(19) United States
(12) Patent Application Publication
(10) Pub. No.: US 2008/0073897 A1
(43) Pub. Date: Mar. 27, 2008

(54) Pop-up photo album

(75) Inventor: Thomas Vincent, Bellingham, WA (US)

Correspondence Address: SIMPSON & SIMPSON, PLLC, 5555 MAIN STREET, WILLIAMSVILLE, NY, 14221-5406, US

(73) Assignee: Umbra LLC, Buffalo, NY (US)

(21) Appl. No.: 11/525,651

(22) Filed: Sep. 22, 2006

(51) Int. Cl. B42D 1/00

(52) U.S. Cl. 281/15.1

(57) ABSTRACT

A book with at least one first page and at least one second page, where the first page and second page are pivotably connected to one another at one end of each page. In some aspects, at least one pop-up assembly with a plurality of folds, which form a lifter segment, a support segment and at least two attachment tabs, have one of said attachment tabs attached to the first page and one of the attachment tabs attached to the second page in a manner that the pop-up assembly can be folded flat or extended varying degrees from the book depending on the orientation of the first page to the second page. At least one sleeve is attached to the lifter segment on the pop-up assembly, wherein the sleeve forms a pocket.

### FIELD OF THE INVENTION

The invention relates generally to a book, and, more particularly, to a photo album or scrapbook that has pop-up apparatuses that hold sleeves that can hold memorabilia, photos and art work.

### BACKGROUND OF THE INVENTION

Pop-up apparatuses are frequently used in advertising and novelty items. Various patents show pop-up items that are made with paper or sheet material having pressure-sensitive adhesive for affixing such item in operative positions. Others have offered techniques to manufacture pop-up items that can facilitate mass production without sophisticated machinery. Some have presented pop-up items that are made of various materials that provide an appearance that was previously not described in the art.

These structures are intended to be single units usually designed to attract the attention or simply decorate the item to which it has been applied. These pop-up items are designed for transitory use within advertisements not long term use. Missing from the art is a pop-up assembly that is designed to be durable and used in a more permanent setting. Also missing is the application of pop-up items in an album for the display of photos or other items. Photo albums and books used to display photos, memorabilia, and art work use a two-dimensional surface to display items. The display of photos and other items in a manner that adds visual depth and variety has yet to be offered.

Thus, there is a need to provide a book to display photos in a way that provides depth and variety to the display of photos, memorabilia, and art work in a book by implementing a structure that enables a three-dimensional presentation.

### SUMMARY OF THE INVENTION

The invention broadly comprises a book with at least one first page and at least one second page, wherein the first page and second page are pivotably connected to one another at one end of each page. In some aspects, at least one pop-up assembly with a plurality of folds, which form a lifter segment, a support segment and at least two attachment tabs, have one of the attachment tabs attached to the first page and one of the attachment tabs attached to the second page in a manner that the pop-up assembly can be folded flat or extended varying degrees from the book depending on the orientation of the first page to the second page. At least one sleeve is attached to the lifter segment on the pop-up assembly, wherein the sleeve forms a pocket.

In some aspects, a cover is attached to the first page and the second page on a side opposite the attachment position of the pop-up assembly. The cover can include a closing element. The first page and second page can also include at least one sleeve attached to a surface of the first and second page. In some aspects, a top layer is attached to a surface of the first and second page and the attachment tabs are inserted in slots in the top layer. The sleeve can have a transparent viewing window. In some embodiments, the attachment tabs are attached using an adhesive and that can be after the attachment tabs are inserted into slots in the first and second pages.

The invention further broadly comprises a book with at least one first page and at least one second page that are pivotably connected at one edge of each page. At least one sleeve can be attached to the first and second page using a pop-up element. In some aspects, the pop-up element has a first leg connected to the first page and a second leg connected to the second page. The pop-element can be operatively arranged to collapse when the first page and the second page are folded toward each other and extend from the book when the first page and second page are folded away from each other. The sleeve can be attached parallel to an upper surface of the lifter segment.

In a some aspects, the book includes a cover to which the first page and second page are connected opposite the attachment position of the pop-up assembly. In some aspects a top layer is attached to a surface of the first page and second page with slots for securing attachment tabs of the first and second legs, where the attachment tabs are inserted in the slots.

The invention also broadly comprises a book with at least one first page and at least one second page pivotably connected to each other. At least one pop-up assembly can be included which has a plurality of folds, where the folds form a lifter segment, a support segment and at least two attachment tabs. One of the attachment tabs can be attached to the first page and one of the attachment tabs can be attached to the second page in a manner that the pop-up assembly can be folded flat or extended varying degrees from the book depending on the orientation of the first page to the second page. In some aspects, at least one transparent sleeve is attached to the lifter segment of the pop-up assembly in parallel with the lifter segment.

At least one sleeve can be attached to the first or second page. In some aspects, the book can include additional pop-up elements that are staggered along the pivotable connection between the first and second page.

It is a general object of the present invention to provide a book with an alternative method of displaying photos, art work and memorabilia.

It is another object of the present invention to provide a book with pop-up assemblies that display photos art work and memorabilia.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a book of the present invention;

FIG. 2 is a top plan view of the book shown in FIG. 1;

FIG. 3 is an elevational view of the book shown in FIG. 1; and,

FIG. 4 is a cross-sectional view of a book of the present invention, taken generally along line 4-4 shown in FIG. 2.

### DETAILED DESCRIPTION OF THE PREFERRED EMBODIMENT

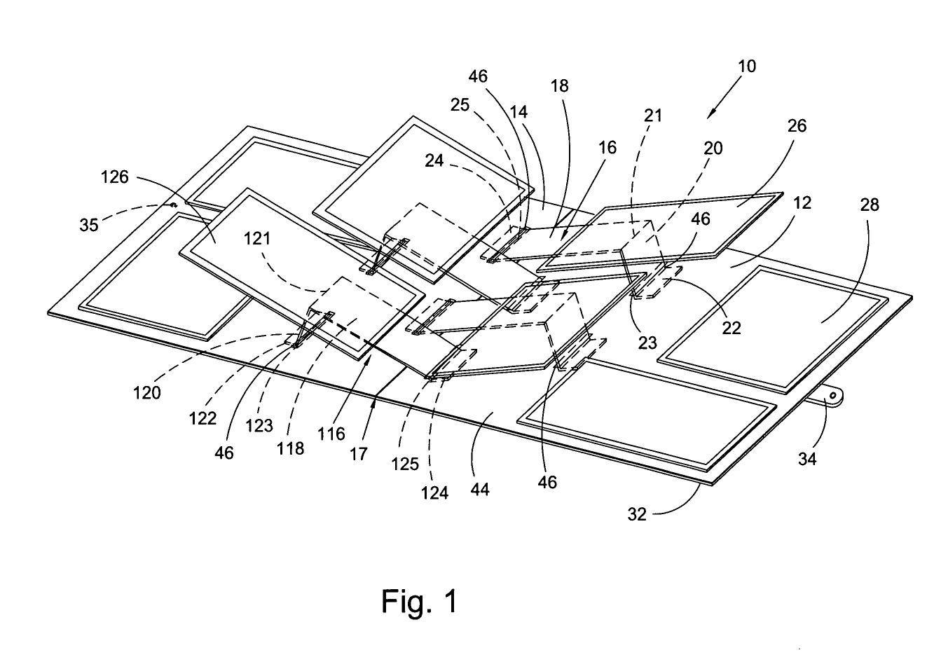

At the outset, it should be appreciated that like drawing numbers on different drawing views identify identical structural elements of the invention. While the present invention is described with respect to what is presently considered to be the preferred embodiments, it is understood that the invention is not limited to the disclosed embodiments. In the description below, the terms “top”, “bottom”, “upper”, “lower”, “front”, “back”, “rear”, “left”, “right”, and their derivatives, should be interpreted from the perspective of one viewing the invention shown in FIG. 1.

Furthermore, it is understood that this invention is not limited to the particular methodology, materials and modifications described and as such may, of course, vary. It is also understood that the terminology used herein is for the purpose of describing particular embodiments only, and is not intended to limit the scope of the present invention.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

In accordance with the present invention and with reference to FIG. 1, a perspective view of book 10 is provided having at least a first page 12 and a second page 14 pivotably connected at one edge of the pages. Book 10 can take various forms including a photo album, scrapbook, or any book capable of holding photos, artwork or memorabilia. The pivotable connection enables page 12 and page 14 to be separated as shown in FIG. 1, or be brought together when the upper surface of pages 12 and 14 are pivoted toward each other. Attached to pages 12 and 14 is pop-up assembly 16, which can have four segments delineated by folds in the pop-up assembly. Pop-assembly 16 can be made from various materials, which can include, but is not limited to paper products, plastic, or various other natural or synthetic materials. Pop-up assembly 16 is shown straddling hinge line 17 with a portion of the pop-up assembly on one side of hinge 17 and a portion on the other side. Lifter segment 18, support segment 20, and attachment tabs or segments 22 and 24 form pop-up assembly 16. Proportions and positioning of segments 20, 22 and 24 can be altered from the proportions and positioning demonstrated in the figures. Note that the figures representing the present invention have portions of the illustrations drawn in dashed or phantom lines to indicate the positioning on that element under another element. Normally, the elements depicted with dashed lines would be hidden from view in the perspectives shown. By depicting these elements in dashed lines the positioning, shape, and function of these dashed lined elements can be understood and the relative positioning of these elements can be perceived as it relates to the non-dashed elements. Dashed leader lines have also been used to clarify which elements are under another element. This convention is used throughout the application.

Lifter segment 18 is defined by fold 21, which designates the point where support segment 20 begins. Support segment 20 is flanked by fold 21 proximate lifter segment 18, and fold 23 proximate attachment tab 22. Tab 24 forms the other end of pop-assembly 16 and is defined by fold 25. The arrangement and number of folds in pop-up assembly 16 can vary depending on the height that the pop-up assembly is designed to rise from the book, the orientation that is desired for items attached to the pop-up assembly, and the size of the items that will be adhered to the pop-up assembly. Folds in pop-up apparatus 16 enable pivoting along the fold lines that enables the pop-up apparatus to collapse when the upper surfaces of pages 12 and 14 are pivoted toward each other, i.e., book 10 is closed. Folds in pop-up apparatus 16 also enables pivoting along the fold lines that enables the pop-up apparatus to extend from the upper surfaces of pages 12 and 14 as the pages are pivoted away from each other, i.e., book 10 is opened.

In the arrangement shown, tab 22 is shown attached to page 12, and tab 24 is shown attached to page 14. In a generally extended position pop-up assembly 16 positions support segment 20 nearly vertical, and approximately perpendicular to page 12 and lifter segment 18. Support segment 20 on page 14 is lifted into approximately an upright position by lifter segment 18 as page 14 is unfolded from page 12. In some embodiments, sleeve 26 is attached directly to lifter segment 18 and is disposed parallel to lifter segment 18. In some aspects, sleeve 26 is a pocket or sleeve that items, such as photos, art work and memorabilia can be placed within. Sleeve 26 can be in a landscape orientation on lifter segment 18 as shown or be in various other orientations. Sleeve 26 could also be attached to pop-up assembly 16 at another location of the pop-up assembly. Sleeve 26 is not relegated to only holding of photos, but sleeve 26 can be used to hold various artwork, memorabilia and items of significance.

Additional sleeves 28 are shown attached to the surface of pages 12 and 14. In some aspects, sleeve 28 is a pocket or sleeve that items, such as photos, art work and memorabilia can be placed within. Cover 32 can be applied to the surface of pages 12 and 14 opposite the side that pop-up assemblies 16 are attached. Cover 32 can be attached to the outer surface of pages 12 and 14 and additional pages 12 and 14 (not shown) similar to the style and content of pages 12 and 14 shown, can be included in book 10. For example, the additional pages 12 and 14 can have sleeves 28 and pop-up assemblies 16 and 116 arranged as described herein, with sleeves 26 attached as described herein. Book 10 can be equipped with closure elements 34 and 35 attached to cover 32 to prevent the inadvertent opening of the book. In some aspects, closure elements 34 and 35 can be any closure means known in the art which can include, but is not limited to a buckle, a hook and loop fastener and snaps.

Pop-up assembly 116 is arranged similarly to pop-up assembly 16, but pop-up assembly 116 is oriented in reverse to pop-up assembly 16. Specifically, tab 122, the counterpart to tab 22, is attached to page 14 instead of page 12. Tab 124, counterpart to tab 24, is attached to page 12 instead of 14. Lifter segment 118, which is attached to page 12, lifts support segment 120 on page 14 into a nearly upright position, which is approximately perpendicular with page 14 and lifter segment 118. Lifter segment 18 has sleeve 26 attached. In some embodiments, sleeve 126 is attached directly to lifter segment 118 and is disposed parallel to lifter segment 118. In some aspects, sleeve 126 is a pocket or sleeve that items, such as photos, art work and memorabilia can be placed within. Sleeve 126 can be oriented on lifter segment 118 in landscape format as shown or be in various other orientations. Sleeve 126 could also be attached to pop-up assembly 116 at another location of the pop-up assembly. Folds in pop-up apparatus 116 enable pivoting along the fold lines that enables the pop-up apparatus to collapse when the upper surfaces of pages 12 and 14 are pivoted toward each other, i.e., book 10 is closed. Folds in pop-up apparatus 116 also enables pivoting along the fold lines that enables the pop-up apparatus to extend from the upper surfaces of pages 12 and 14 as the pages are pivoted away from each other, i.e., book 10 is opened.

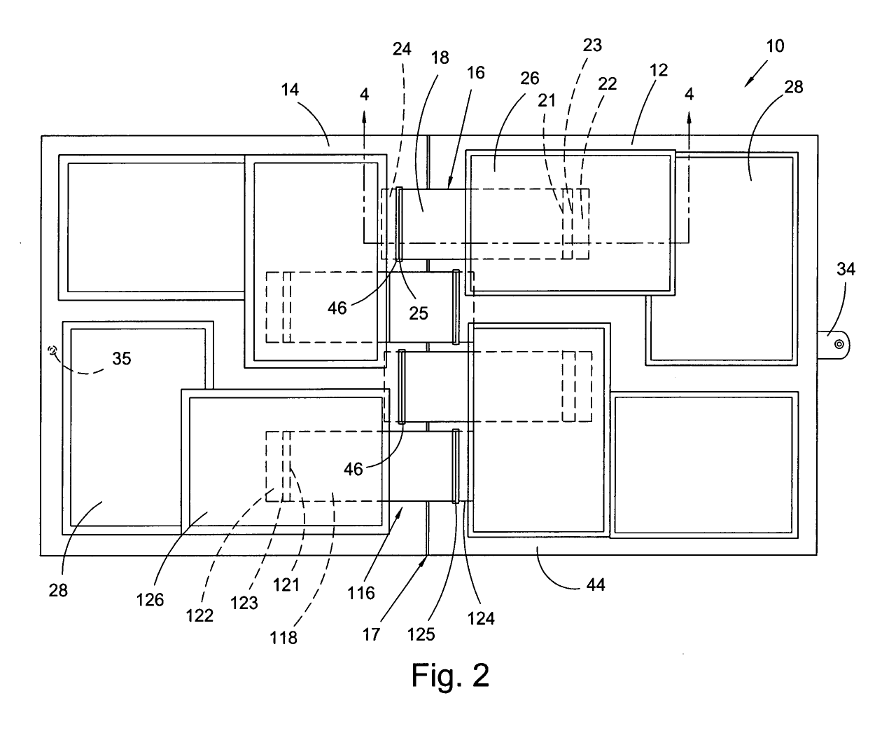

FIG. 2 is a top plan view of book 10 in an open position. An opened book 10 enables pop-up assemblies 16 and 116 to be fully expanded to reveal sleeves 26 and 126 and sleeves 28. Pop-up assemblies 16 and 116 lift off of the pages 12 and 14 to add a three-dimensional aspect to book 10. As described supra, lifter segments 18 and 118 draw support segments 20 and 120 into a more upright position as pages 12 and 14 are moved away from each other. The degree that book 10 is opened, in other words the degree that pages 12 and 14 are separated from each other, will determine the angle of support members 20 and 120. Pop-up assemblies 16 and 116 can be made from various materials including, but not limited to fabric, paper, cardboard, cardstock, plastic, etc.

The orientation of sleeve 26 in a landscape view, and sleeve 126 in a vertical arrangement exemplifies two possible positions that the sleeves attached to the pop-up assemblies can be arranged. However, sleeve 26 can be arranged at various angles and positions on pop-up assemblies 16 and 116. The sleeves are depicted as rectangular pockets that hold photos, but it should be understood that the shape of the sleeves can take on various shapes.

In some aspects, sleeves 28 can be placed on the surface of pages 12 and 14 of book 10. The positioning of sleeves 28 are shown in landscape or vertical arrangements, but sleeves 28 can differ from the arrangement, being arranged at various angles and positions on pages 12 and 14. The size and shape of sleeves 28 can also vary.

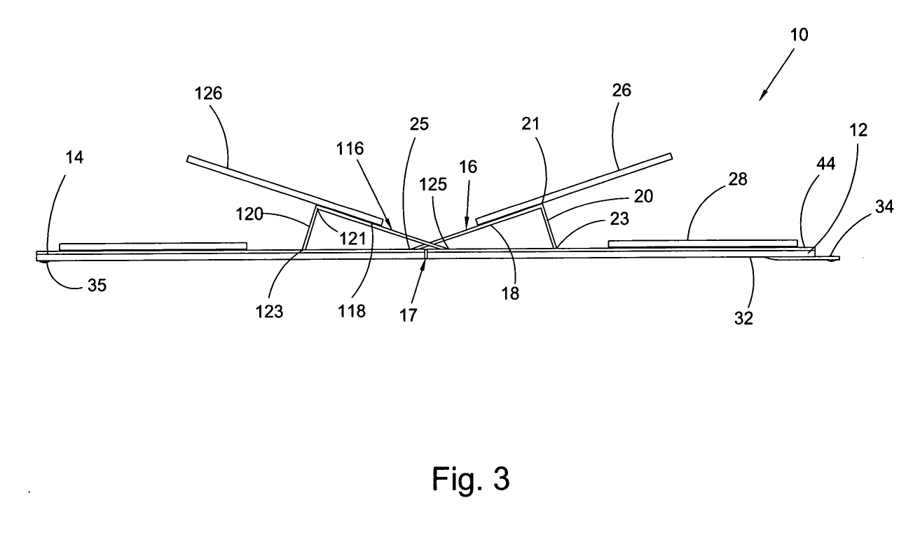

FIG. 3 is a side elevational view of book 10 fully open with pages 12 and 14 rotated roughly 180 degrees from each other, and roughly 90 degrees from a closed position. In this open position, pop-up apparatuses 16 and 116 are near full extension with support segments 20 and 120 holding up lifter segments 18 and 118, respectively. Fold 23 between tab 22 and support segment 20, fold 21 between support segment 20 and lifter segment 18, and fold 25 between lifter segment 18 and tab 24 enable pop-up assembly 16 to raise and lower relative to page 12, and ultimately collapse when book 10 is closed. Fold 123 between tab 122 and support segment 120, fold 121 between support segment 120 and lifter segment 118, and fold 125 between lifter segment 118 and tab 124 enable pop-up assembly 116 to raise and lower relative to page 14, and ultimately collapse when book 10 is closed. In some aspects, support segments 20 and 120 can be positioned roughly perpendicular to pages 12 and 14, respectively, when in an expanded position. However, the angle that support segments 20 and 120 are arranged depends on the placement of tabs 22 and 122 that attach the support segments to book 10. Positioning tabs 22 and 122 closer to or further away from hinge line 17 can result in support segments 20 and 120 being arranged at various angles when book 10 is opened. Repositioning tabs 22 and 122 on different points on pages 12 and 14 can also affect the height and angle of lifter segments 18 and 118 and the attached sleeves. Repositioning of tabs 25 and 125 at a different position on lifter segments 18 and 118 can also influence the angle of support segments 20 and 120 in the open position. The position of tabs 25 and 125 can also alter the height and angle of lifter segments 18 and 118.

In this perspective shown in FIG. 3 it is seen that sleeve 26 and 126 are shown attached to pop-up assemblies 16 and 116 a slight distance from hinge line 17 of book 10. Positioning of sleeves 26 and 126 on pop-up assemblies 16 and 116 can vary from the depicted embodiment.

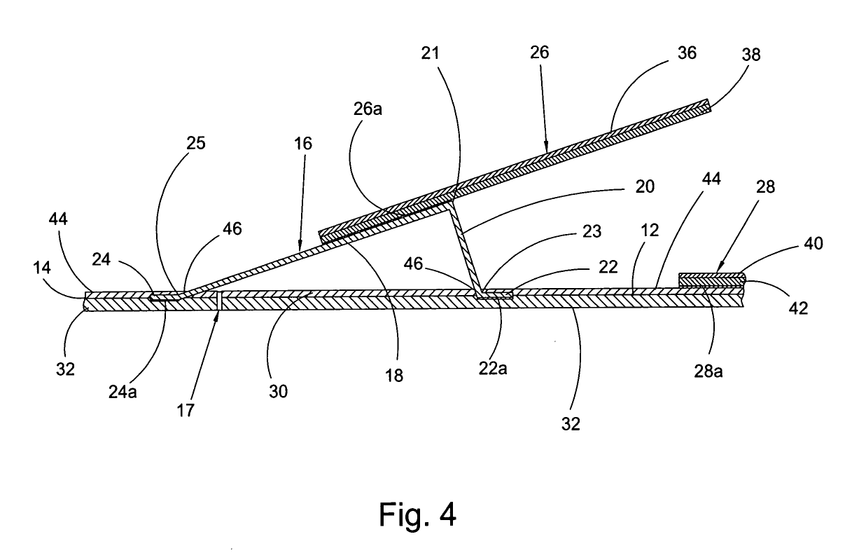

FIG. 4 is a cross-sectional view of book 10 taken generally along line 4-4 shown in FIG. 2. In some aspects, sleeve 26 is attached to lifter segment 16 with adhesive 26a, but any means of attachment known in the art could be substituted. Sleeve 26 is shown having transparent layer 36 attached to backing 38. Transparent layer 36 can be attached to the outer perimeter of backing 38 on three sides leaving a top edge unattached to form a pouch or sleeve with an opening where items can be inserted. In some aspects, transparent layer 36 has a solid border (not shown). Transparent layer 36 can also be secured on a single side to form a folder of sorts, and an adhesive substance can be applied to backing 38 to secure photos and other art to the sleeve (not shown). Alternatively, static can be used to attach photos to sleeve 126. Additional alterations of sleeve 26 can be introduced and such variations on sleeve 26 are within the spirit and scope of the invention.

The attachment of sleeve 126 to lifter segment 116 is similar to the attachment of sleeve 26 to lifter segment 16 described above. Variations on sleeve 126 is similar to the variations of sleeve 26 described above. Specifically, sleeve 126 can have a transparent layer attached to a backing to form a pouch to hold photos or the transparent layer can be attached to the backing to form a folder and an adhesive can be applied to the surface of the backing to secure photos to sleeve 126. A solid border can also be part of the transparent layer to produce a frame effect for items placed in sleeve 126. In some aspects, static is used to attach photos to sleeve 126.

Sleeves 28 are shown attached to the surface of book 10 by adhesive 28a. In some aspects, sleeves 28 have a transparent layer 40 attached to backing 42. Transparent layer 40 can have a solid border around the perimeter of the transparent layer 40 and a window is formed, through which items placed in the sleeve can be viewed. In some aspects, transparent layer 40 is attached to only the perimeter of three sides of backing 42. However, alternative arrangements are considered within the spirit and scope of the invention. For instance, one possible variation is to secure transparent layer 40 on a single edge of backing 42 to form a folder, and an adhesive substance can be applied to backing 42 to secure photos and other art to sleeve 28 (not shown). Alternatively, static can be used to attach photos to sleeve 28 by implementing a static generating material or surface on transparent layer 40 and/or backing 42.

In FIG. 4, pop-up assembly 16 is shown attached to page 12 at tab 22, and to page 14 at tab 24. In some aspects, tab 24 is attached to page 14 by adhesive 24a or some other attachment means known in the art. In some aspects, top layer 30 is made of material, such as fabric, paper, cardboard, cardstock, plastic, etc. is applied on the inner surface of pages 12 and 14, covering tabs 22 and 24. Top layer 30 can be applied to add aesthetic interest and/or strength to the tab connection. Slots 46 in top layer 30 can be added to create an insertion and attachment point for tabs 22 and 24.

Pop-up assembly 116 have a similar attachment arrangement as shown and described supra for pop-up assembly 16. For example, pop-up assembly 116 can be attached to page 12 at tab 124, and to page 14 at tab 122. In some aspects, tab 124 is attached to page 12 by adhesive or some other attachment means known in the art. In some aspects, top layer 30 is made of material, such as fabric, paper, cardboard, cardstock, plastic, etc. is applied on the inner surface of pages 12 and 14, covering tabs 122 and 124. Top layer 30 can be applied to add aesthetic interest and/or strength to the tab connection. Slots in top layer 30 can be added to create an insertion and attachment point for tabs 122 and 124.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A book, comprising:
at least one first page and at least one second page, wherein said first page and second page are pivotably connected to one another at one end of each page;
at least one pop-up assembly having a plurality of folds, wherein said folds form a lifter segment, a support segment and at least two attachment tabs, wherein one of said attachment tabs is attached to said first page and one of said attachment tabs is attached to said second page in a manner that said pop-up assembly can be folded flat or extended varying degrees from said book depending on the orientation of said first page to said second page; and,
at least one sleeve attached to said pop-up assembly on said lifter segment, wherein said sleeve forms a pocket.

2. The book of claim 1, further comprising a cover to which said first and said second page are connected, said connection on a side opposite said attachment position of said pop-up assembly.

3. The book of claim 2, wherein said cover further comprises a closing element.

4. The book of claim 1, wherein said first and second page further comprise at least one sleeve attached to a surface of said first and second page.

5. The book of claim 1, further comprising a top layer attached to a surface of said first and second page with slots for said attachment tabs.

6. The book of claim 1, wherein said sleeve has a transparent window.

7. The book of claim 1, wherein said attachment tabs are attached using an adhesive.

8. The book of claim 7, wherein said attachment tabs are inserted into slots in said first and second pages.

9. A book, comprising:
at least one first page and at least one second page, wherein said first page and second page are pivotably connected at one edge of each page; and,
at least one sleeve attached to said first and second page using a pop-up element, wherein said pop-up element has a first leg connected to said first page and a second leg connected to said second page, said pop-element is operatively arranged to collapse when said first page and said second page are folded toward each other and extend from the book when said first page and second page are folded away from each other, wherein said sleeve is attached parallel to an upper surface of said lifter segment.

10. The book of claim 9, further comprising a cover to which said first and second page are connected, said connection on a side opposite said attachment position of said pop-up assembly.

11. The book of claim 10, wherein said cover further comprises a closing element.

12. The book of claim 8, further comprising at least one sleeve attached to a surface of said first or second page.

13. The book of claim 8, further comprising a top layer attached to a surface of said first and second page with slots for securing attachment tabs of said first and second legs, wherein said attachment tabs are inserted in said slots.

14. The book of claim 8, wherein said sleeve has a transparent window.

15. The book of claim 13, wherein said attachment tabs are attached using an adhesive.

16. The book of claim 15, wherein said attachment tabs are inserted into slots in said first and second pages.

17. A book, comprising:
at least one first page and at least one second page pivotably connected to each other;
at least one pop-up assembly having a plurality of folds, wherein said folds form a lifter segment, a support segment and at least two attachment tabs, wherein one of said attachment tabs is attached to said first page and one of said attachment tabs is attached to said second page in a manner that said pop-up assembly can be folded flat or extended varying degrees from said book depending on an orientation of said first page to said second page; and,
at least one transparent sleeve attached to said lifter segment of said pop-up assembly in parallel with said pop-up assembly; and,
at least one sleeve attached to said first or second page.

18. The book of claim 17, wherein said attachment tabs are connected attached using an adhesive.

19. The book of claim 17, further comprising a cover attached to said book opposite the attachment position of the pop-up elements and sleeves.

20. The book of claim 17, further comprising additional pop-up elements that are staggered along a joint at said pivotable connection between said first and second page.
